(19) United States
(12) Patent Application Publication
(10) Pub. No.: US 2004/0226127 A1
(43) Pub. Date: Nov. 18, 2004

(54) Heated windshield wiper system employing pulsed high speed fluid impingement jets for cleaning and ice/snow removal

(76) Inventor: Jerome J. Kaplan, Northbrook, IL (US)

Correspondence Address: Gerald M. Newman, 222 S. Riverside Plaza, Suite 2100, Chicago, IL, 60606, US

(21) Appl. No.: 10/435,305

(22) Filed: May 12, 2003

(51) Int. Cl. B60S 1/46; B60S 1/52

(52) U.S. Cl. 15/250.04; 15/250.05; 239/128; 239/130; 239/284.1

(57) ABSTRACT

A windshield cleaning system has a pump supplying washer fluid through a heat exchanger to a dispenser tube equipped with a plurality of nozzles in a spaced pattern. The fluid is dispensed in pulses to enhance its heating effect and improve system efficiency. The average pulsatile flow rate is such that operation of the system with a one-gallon reserve is feasible for about 30 minutes under extreme climatic conditions of temperature, snow, ice and/or freezing rain.

### BACKGROUND OF THE INVENTION

This invention relates generally to windshield wiper systems for automobiles and particularly to heated windshield cleaning systems that are especially adapted for operation under adverse conditions of ice, snow, and/or freezing rain. Conventional windshield cleaning systems use a pump to supply windshield washer fluid from a reservoir to a windshield via one or more nozzles that may either be stationary or located in a mechanism that is carried by a windshield wiper. The washer fluid is at ambient temperature but is protected from freezing by the addition of alcohol or the like. Under extreme adverse conditions of low temperature and/or ice, snow or freezing rain, the combination of temperature and air movement over a cold windshield may result in the washer fluid freezing on the windshield, not only defeating the cleaning system, but in most cases adversely affecting visibility and making driving either impossible or inadvisable. Therefore, these systems are only useful when the ambient temperature is not less than approximately 25 degrees, or when the vehicle windshield is thoroughly warmed. The prior art includes many windshield-cleaning systems that are intended for operation under such extreme adverse climatic conditions. Most employ some system for heating the windshield washer fluid, either electrically from the vehicle battery or with heat from the vehicle engine. Use of the vehicle battery is not desirable because of the heavy electrical drain required to heat the washer fluid sufficiently to perform deicing under severe climatic conditions. The use of the engine requires that the engine be operated for a sufficient period of time to generate the necessary heat which involves a substantial delay in operation of the system.

In the case of stationary nozzle systems, with nozzles located about one foot from the windshield and continuously ejecting washer fluid at a velocity of about 20 feet per second, copious quantities of washer fluid are required. Under an extreme case scenario, in such a system having a standard one-gallon washer fluid reservoir, the reservoir could be entirely emptied in just a few minutes of operation. Systems with movable nozzles, i.e., nozzles carried by a wiper blade, represent an improvement in that the continuously ejected washer fluid is delivered closer to the windshield, and in multiple locations, as the wiper blade moves over the windshield. In either type system, the heat transfer between the washer fluid and the windshield is inefficient, requiring excessive electrical energy and/or copious quantities of washer fluid. Some of these systems appear to be useful and effective over a limited range of climatic environments, but none appear to be satisfactory for use under extreme adverse climatic conditions of low temperature, ice, snow and/or freezing rain.

The system of the present invention avoids many of the prior art problems and thus affords numerous advantages thereover. Among the features of the present invention system are: optimization of the use of the heated washer fluid over the swept area of the windshield by pulsing the operation of the dispensing nozzles; utilization of a plurality of directed nozzles to provide high speed washer fluid velocities close to the windshield; maximization of the heating effect of the washer fluid with high speed fluid impingements that spread radially outward from the point of impact with the windshield surface; and direction of the fluid to the wiper mechanism itself to prevent or clear any ice buildup thereon.

### OBJECTS OF THE INVENTION

A principal object of the invention is to provide a novel windshield cleaning system.

Another object of the invention is to provide a windshield cleaning system that is effective under extreme adverse climatic conditions.

A further object of the invention is to provide a heated fluid windshield cleaning system with enhanced heat transfer characteristics.

### BRIEF DESCRIPTION OF THE DRAWINGS

These and other objects and advantages of the invention will be apparent upon reading the following description in conjunction with the drawings in which:

FIG. 1 is the side view of a windshield wiper equipped with a fluid dispensing tube in accordance with the invention;

FIG. 2 is a top view of FIG. 1;

FIG. 3 is an enlarged cross section taken along lines 3-3 of FIG. 1;

FIG. 4 is an enlarged cross section taken along lines 4-4 of FIG. 1;

FIG. 5 is a simplified schematic diagram of the control system for the windshield cleaning arrangement of the invention;

FIG. 6 is a simplified cross section of a heat exchanger useful with the invention; and

FIG. 7 is a sectional view taken along the line 7-7 of FIG. 6.

### DETAILED DESCRIPTION OF THE INVENTION

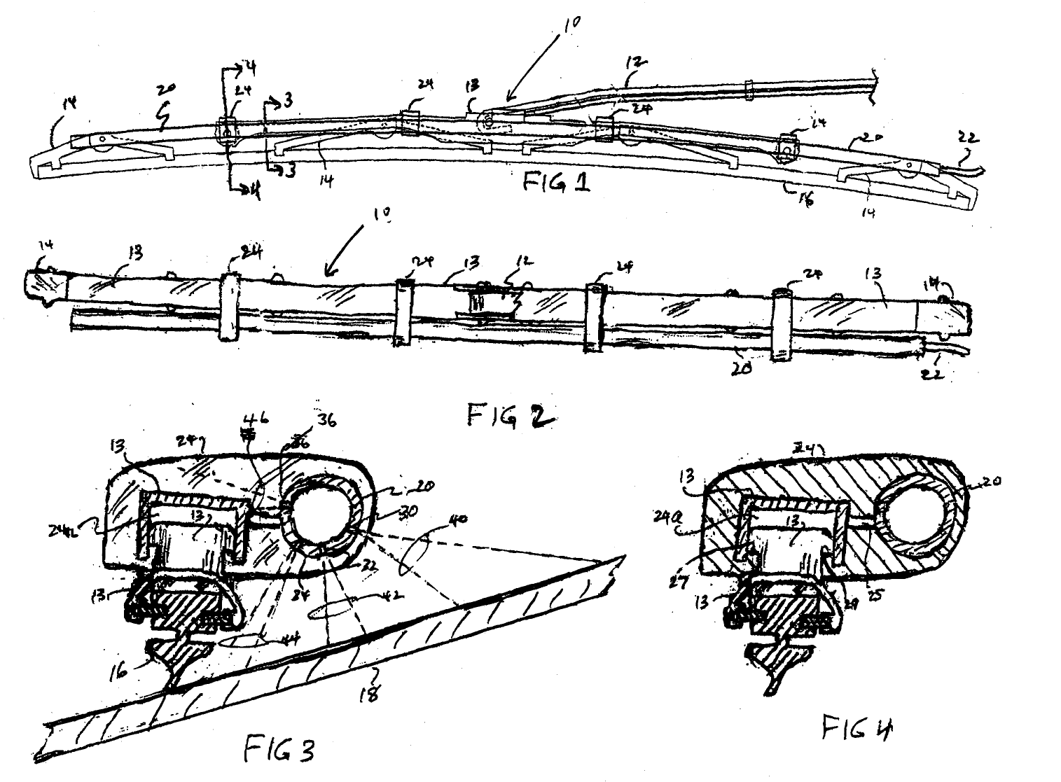

Referring to FIGS. 1 and 2, a typical windshield wiper 10 includes an arm 12, to which is removably attached an elongated, generally U-shaped frame 13 which supports a plurality of hinged carriers 14 that, in turn, support a wiper blade 16. The arm 12 is spring-loaded toward a flat or curved windshield 18 (FIG. 3) and the hinged carriers 14 enable close contact operation with the windshield. The wiper blade mechanism and its operation are well known in the art and are therefore not described in detail.

As alluded to above, in popular windshield cleaning systems, a washer fluid reservoir, fluid pump and fluid piping are situated beneath the hood of a vehicle for supplying washer fluid to a pair of nozzles, generally located on the hood. Responsive to operation of a control switch, washer fluid is pumped through the nozzles, in one or more continuous jets, to fixed locations on the windshield. In another system, the nozzles are situated in a dispensing tube that is carried by the wiper frame and the washer fluid is ejected in a continuous spray pattern. This latter system is similar to that of the present invention, in that a rigid dispenser tube 20, supplied with heated washer fluid through a flexible pipe 22, is secured to the wiper frame 13 by a plurality of clamps 24. The arrangement of the fluid reservoir, fluid heater and pump beneath the hood of a vehicle and the fluid piping to the dispensing tube or nozzles is not illustrated, as they form no part of the present invention. Conventional circular nozzles have diameters in the range of 0.04 in.-0.06 in., whereas slot shaped nozzles measure about 0.125 in. by 0.187 in. It will be appreciated by those skilled in the art that the invention is not limited to an “after market” add-on system, as shown. Rather, the wiper frame may incorporate structure similar to dispenser tube 20 in its construction, eliminating the need for clamps 24.

As best seen in the cross sectional view of FIG. 3, dispenser tube 20, which may have an internal diameter of about 0.25 inches and a wall thickness of about 0.025 inches, includes a plurality of radially-outward directed nozzles 30, 32, 34 and 36 formed in the wall thereof. Three of the nozzles 30, 32 and 34 direct washer fluid sprays 40, 42 and 44, respectively, toward the windshield 18 while nozzle 36 directs a washer fluid spray 46 toward the wiper frame 13. In practice, each dispenser tube 20 incorporates about 40 nozzles, having diameters in the range of 0.015-0.020 inches, with the disclosed patterns being spaced about every two inches along the length of the dispenser tube. The total number of nozzle patterns is a function of the length of the wiper blade, with about ten patterns for a typical two-foot blade.

The nozzles deliver pulsed jets of washer fluid, of round cross section, to the windshield. The jet impingements are displaced by several diameters of the spray tube, which takes advantage of the enhanced heat transfer characteristics of pulsed jets of heating/cooling liquids. The thermal exchange characteristics of such pulsed jets are well known and discussed at the following Internet web sites.

http://www.coolingzone.com/Content/DesinCorner/Problem/Problem9.html and

http://www.vok.1th.se/HT/RESEARCH/Andreas/Cooling%20gas% gas%20turbine %20combus

With the pulsed jets of the invention, very effective impingement heating occurs, not only at the first point of contact with the windshield, but at as many as ten jet diameters away as the impinging jet spreads radially outward from the point of contact. The washer fluid is heated between 100° F. and 120° F. and delivered at a pressure of 30-40 psi gauge. The jet velocity at the nozzle is in the range of 50-80 feet per second, and with an average of 40 nozzles per wiper arm, the system has a pulsatile average flow rate of 1/30 gallon per minute. Therefore, with a one-gallon reservoir, the system is capable of operation under extreme adverse conditions for about 30 minutes, which is sufficient to enable emergency driving through snow and ice storms, if required. The pulsing of the jets maximizes the heating effects of the washer fluid since the washer fluid retained on the windshield surface has a heating effect for a time after the jet has ceased. The result is that the area of coverage can be made much larger for the quantity of washer fluid used.

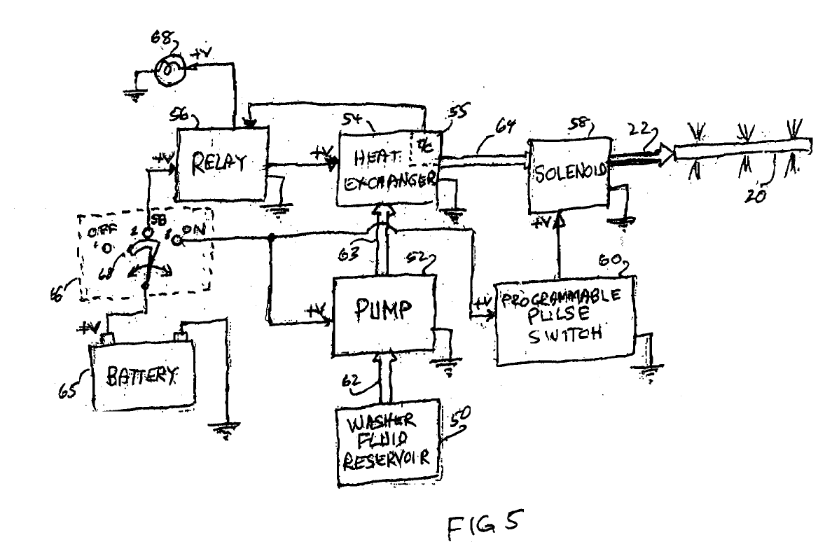

FIG. 4 is a cross section through one of the clamps 24, showing its elongated C shaped configuration. A U-shaped opening 24a, for encompassing the frame 13, and a circular opening 24b, for embracing the dispenser tube 20, are formed therein. A slit 25 permits clamp 24, which is fabricated of a resilient material such as rubber, to be opened to embrace the dispenser tube and to enable projections 27 and 29, that extend into U-shaped opening 24a, to firmly grasp the depending side portions of frame 13.

FIG. 5 shows a simplified schematic diagram of the system of the invention. A washer fluid reservoir 50 is connected by a fluid pipe 62 to a fluid pump 52 that is, in turn, connected by a fluid pipe 63 to a heat exchanger 54. Heat exchanger 54 is coupled through a fluid pipe 64 to a solenoid 58 that is coupled to flexible pipe 22, which is connected to dispenser tube 20. It will be appreciated that the other fluid pipes may be rigid or flexible, whichever is most convenient. A relay 56 is connected to control the flow of DC battery current to heat exchanger 54, which includes a thermocouple arrangement 55 connected in a feedback loop to relay 56 for maintaining the washer fluid in heat exchanger 54 between 100° F. and 120° F. A 12 Volt DC battery 65 has its positive terminal +V connected to the movable wiper contact 68 of a switch 66 and its negative terminal connected to ground. Switch 66 has as a No. 1 (OFF) position, a No. 2 standby (S/B) position and a No. 3 (ON) position. Movable contact 68 has a curved portion that connects only to the S/B contact when in the No. 2 position and to both the S/B contact and the ON contact when the switch is in its No. 3 ON position. The S/B contact is connected to relay 56 and the ON contact is connected to pump 52 and to a programmable pulse switch 60, that in turn, supplies +V operating potential to solenoid 58. Lastly, relay 56 is connected to an indicator lamp 68, which along with switch 66, is mounted in the passenger compartment of a vehicle. All other elements, except flexible pipe 22 and dispenser tube 20, are mounted under the hood of the vehicle.

In operation, the vehicle operator moves switch 66 from its No. 1 OFF position to its No. 2 S/B position when operation of the heated wiper system is desired. Energy from battery 65 is supplied through relay 56 to heat exchanger 54 and heats washer fluid therein to the specified range of 100° F.-120° F., with the thermocouple feedback loop cycling relay 56 as required. Indicator light 68 is illuminated to signal the vehicle operator that the cleaning system is activated. When heated washer fluid is desired to be supplied to dispenser tube 20, switch 66 is moved in its No. 3 ON position, which results in DC voltage being additionally supplied to pump 52 and programmable pulse switch 60. Pump 52 operates to pressurize the system (30-40 psig) and heated washer fluid is made available to solenoid 58. Simultaneously, programmable pulse switch 60 is activated to supply pulsed operating potential to solenoid 58, which responds by supplying pressurized, heated washer fluid to dispenser tube 20 for ejection from the nozzles onto the windshield surface. The frequency of operation of pulse switch 60 may be varied for climatic conditions, with the benefits of the invention being realized when the frequency is in the range of 60-80 pulses/minute.

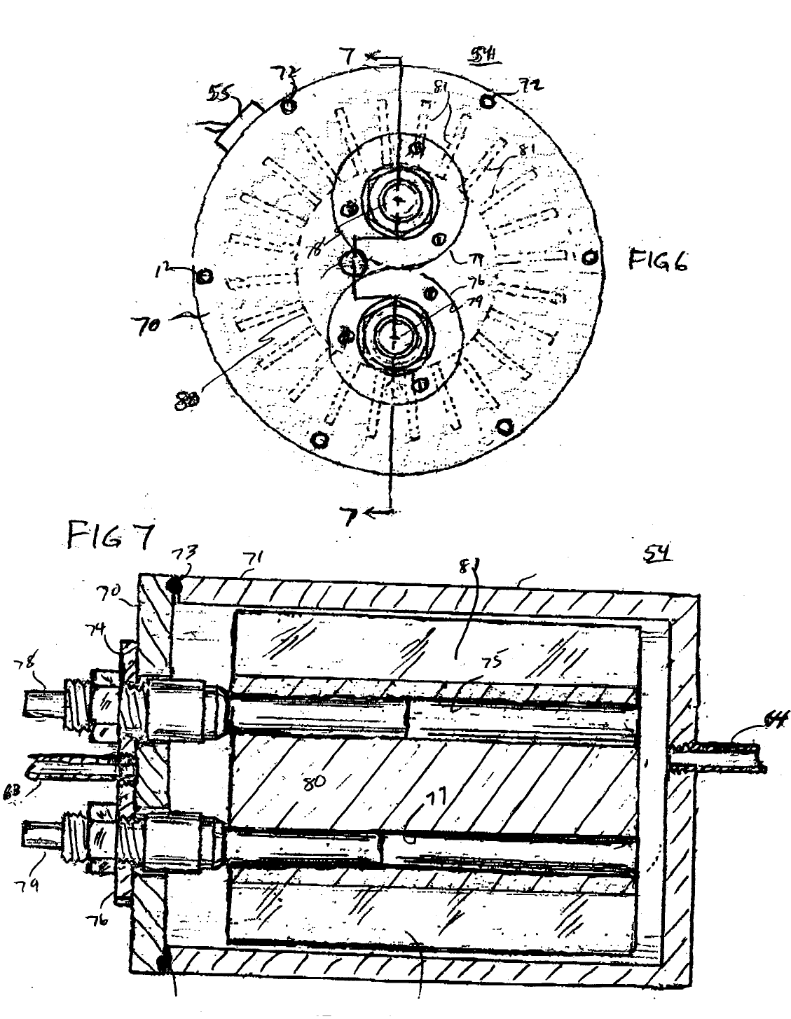

FIGS. 6 and 7 illustrate construction of the heat exchanger 54 used in the invention. It generally comprises a cylindrically shaped housing 71 with a circular cover 70 through which protrude a pair of electrical heating units 78 and 79 that have threaded ends. Housing 71 and cover 70 may be fabricated of plastic. Cover 70 is secured to housing 71 by screws 72. An O ring 73 is compressed to form a seal between cover 70 and housing 71. A pair of heating unit mounting plates 74 and 76 have holes to accommodate the respective heating units and are secured to cover 70 by any well-known means, such as screws. An aluminum core 80 includes a pair of cylindrical holes 75 and 77 that are sized to frictionally receive the heating units 78 and 79. The core has a plurality of outwardly radiating aluminum fins for heat dissipation purposes. Cover 70 includes a suitably threaded hole for receiving washer fluid pipe 63 and the base of housing 71 includes a similar threaded hole for receiving a washer fluid pipe 64.

Heating units 78 and 79 pass through suitable holes in mounting plates 74 and 76, respectively and are secured thereto by appropriate nuts. Washer fluid enters the heat exchanger through fluid pipe 63, flows over the heated core 80 and exits through fluid pipe 64 in response to operation of solenoid 58, as described above. The heating elements 78,79 are rated at 30 amperes (360 watts) each and are embedded in the cylindrical aluminum core 80. Since the core of the heat exchanger heats up rapidly, an additional reserve of standby heated washer fluid is not required. The heat exchanger is capable of raising the temperature of the washer fluid from 100° F. to 120° F. with about 750 watts dissipation. The thermocouple control 55 maintains the core temperature at slightly less than 212° F. in the event the fluid reservoir is used up. This feature also speeds initial warm-up of the heat exchanger, which takes less than one minute.

Normally the washer fluid temperature is 100° F. when the ambient temperature is 0° F. Washer fluid at this temperature can be maintained at this ambient temperature with a flow rate of 1/30th of a gallon per minute. Thus arrangement eliminates the need for a standby reserve of heated washer fluid and improves system efficiency and economy.

What has been described is a novel heated windshield cleaning system for operation under extreme adverse climatic conditions. It is recognized that numerous changes to the described embodiment of the invention will be apparent to those skilled in the art without departing from its true spirit and scope. The invention is to be limited only as defined in the claims.

1. A windshield cleaning system comprising:
a reservoir of windshield washer fluid;
a windshield wiper;
a heat exchanger for heating washer fluid;
a fluid pump;
a control switch coupled to said heat exchanger and to said fluid pump;
fluid piping interconnecting said reservoir, said heat exchanger, said fluid pump, and said windshield wiper;
a dispenser tube, including a pattern of fluid dispensing nozzles, carried by said windshield wiper; and
said control switch energizing said pump for delivering high pressure heated washer fluid from said heat exchanger, to said dispenser tube and through said nozzles onto said windshield for cleaning and deicing thereof.

2. The cleaning system of claim 1, further including:
a controllable valve in said fluid piping between said heat exchanger and said dispenser tube;
a pulse switch connected to said controllable valve; and
said control switch activating said pulse switch whereby said controllable valve supplies said high pressure heated washer fluid to said dispenser tube in a pulsing manner.

3. The cleaning system of claim 2, wherein said pulse switch is programmable to vary the rate at which said controllable valve supplies said heated high pressure washer fluid to said dispenser tube.

4. The cleaning system of claim 3, wherein said fluid pump maintains a pressure in the range of 30-40 psig.

5. The cleaning system of claim 4 further including:
a thermocouple control coupled to said heat exhanger for maintaining the temperature of said washer fluid between 100° F. and 120° F.

6. The cleaning system of claim 1, wherein said dispensing nozzles in said dispenser tube are between 0.015 to 0.020 inches in diameter.

7. The cleaning system of claim 6, wherein the velocity of said heated washer fluid ejected from said nozzles is on the range of 50 to 80 feet/second.

8. The cleaning system of claim 1, further including a relay, controlled by said switch, for controlling power to said heater reservoir.

9. A windshield cleaning system comprising:
a reservoir of windshield washer fluid;
a windshield wiper;
a heat exchanger for heating washer fluid;
a fluid pump;
a control switch coupled to said heat exchanger and to said fluid pump;
fluid piping interconnecting said reservoir, said heat exchanger, said fluid pump, and said windshield wiper;
a dispenser tube, including a pattern of fluid dispensing nozzles, carried by said windshield wiper; a controllable valve in said fluid piping between said heat exchanger and said dispenser tube;
a programmable pulse switch, for varying the rate at which said controllable valve supplies said heated high pressure washer fluid to said dispenser tube, connected to said controllable valve;
said control switch activating said programmable pulse switch whereby said controllable valve supplies said high pressure heated washer fluid to said dispenser tube in a pulsing manner. and
said control switch energizing said pump for delivering high pressure heated washer fluid from said heat exchanger to said dispenser tube and through said nozzles onto said windshield for cleaning and deicing thereof.

10. The cleaning system of claim 9, wherein said fluid pump maintains a pressure in the range of 30-40 psig.

11. The cleaning system of claim 10 further including:
a thermocouple control coupled to said heat exchanger for maintaining the temperature of said washer fluid between 100° F. and 120° F.

12. The cleaning system of claim 11, wherein said dispensing nozzles in said dispenser tube are between 0.015 to 0.020 inches in diameter.

13. The cleaning system of claim 12, wherein the velocity of said heated washer fluid ejected from said nozzles is on the range of 50 to 80 feet/second.
